(19) United States
(12) Patent Application Publication
(10) Pub. No.: US 2018/0313394 A1
(43) Pub. Date: Nov. 1, 2018

(54) CAPTIVE FASTENER

(71) Applicant: Harcourt Industrial, Inc., Madison Heights, MI (US)

(72) Inventor: Dale Beardmore, Rochester Hills, MI (US)

(21) Appl. No.: 15/968,557

(22) Filed: May 1, 2018

Related U.S. Application Data
(60) Provisional application No. 62/492,808, filed on May 1, 2017.

(51) Int. Cl. F16B 41/00; F16B 5/02; F16B 37/08

(52) U.S. Cl. CPC F16B 41/002; F16B 37/0871; F16B 5/0208

(57) ABSTRACT

A captive fastener having a bushing with an internal bore extending through the bushing. A snap ring is mounted within the internal bore. A fastener having an elongated shaft mounted within the bore and adapted to reciprocate within the bore between retracted and extended positions. The free end of the fastener has threads and a flat wall adjacent the threads. A snap ring engages the bolt when the shaft is extended and retracted, the flat wall prevents the snap ring from engaging the threads.

### RELATED APPLICATIONS

This application claims the benefit of U.S. Provisional Application Ser. No. 62/492,808, filed May 1, 2017, which is incorporated herein by reference in its entirety.

### STATEMENT REGARDING FEDERALLY SPONSORED RESEARCH

NONE.

### TECHNICAL FIELD

This invention relates generally to captive fasteners and more particularly to an improved captive fastener with bolt retention.

### BACKGROUND OF THE INVENTION

Captive fasteners are well known in the manufacturing industry. A captive fastener is typically a fastener that is held in a bushing to prevent the fastener from being inadvertently removed from the bushing. The fastener can reciprocate within the bushing between a fastened position and unfastened position. The purpose is to keep the fastener attached to the bushing so that it is not lost. The bushing is mounted for example to a first work surface in a manner to prevent unintended removal. The bushing could be pressed in, threaded, deformed, or mounted with a secondary fastener such as a locking screw. Many captive fasteners use thread locking, press-fitting, or broaching to accomplish their anchor-hold within the larger assembly housing. However, some captive fasteners meld with the material into which they are joined, either through cold forming or welding.

The fastener is intended to be fastened to a second work surface by pushing the fastener into the bushing and then fastening the fastener to a receiver in or adjacent the second work surface. The fastener and receiver can take many forms, for example, it could be a t-fastener which fits in a slotted fastener, a threaded end that is threaded into a nut, etc. Captive fasteners are designed for permanent retention within their target assembly or housing providing a secure joint and avoiding loss or damage that might be caused by a loose part.

A major problem with threaded fasteners is that the fastener has the ability to be threaded out of the bushing. The bushing typically has a snap ring that biases against the fastener shaft. However, the end of the shaft is threaded which frequently results in the fastener being “unthreaded” from the bushing if the fastener is rotated to many times. Additionally, even if the fastener is not freed from the bushing, if the snap ring is engaged by the threads, it will sometimes interfere with rapid deployment of the fastener to the receiver.

### SUMMARY OF THE INVENTION

In general terms, this invention provides an improved captive fastener that better ensures that the fastener, particularly a threaded fastener is not inadvertently removed from the bushing.

These and other features and advantages of this invention will become more apparent to those skilled in the art from the detailed description of a preferred embodiment. The drawings that accompany the detailed description are described below.

### BRIEF DESCRIPTION OF THE DRAWINGS

FIG. 1 is a perspective view of the captive fastener of the present invention.

FIG. 2 is a perspective view of the captive fastener of the present invention illustrating an example of how the captive fastener is used.

FIG. 3 is a cutaway view of the captive fastener of the present invention.

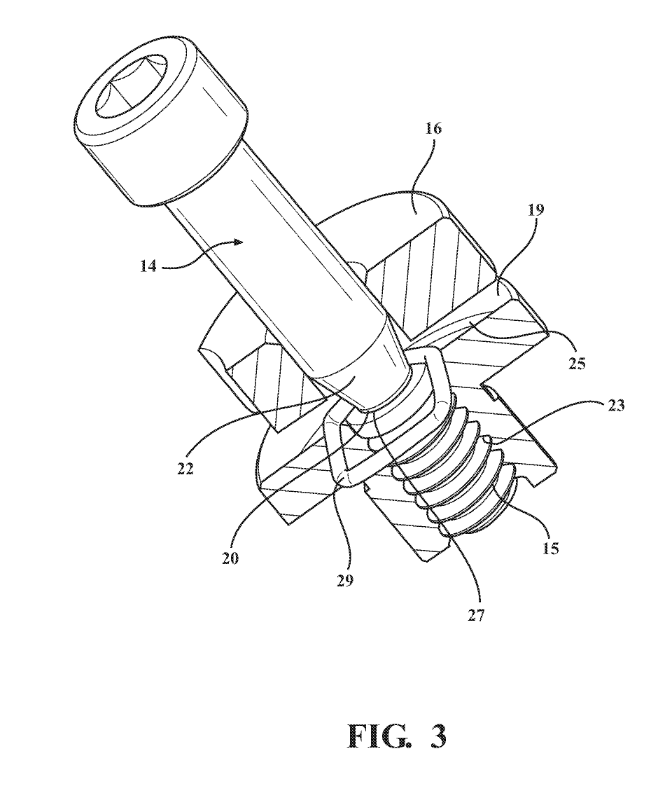

### DETAILED DESCRIPTION OF A PREFERRED EMBODIMENT

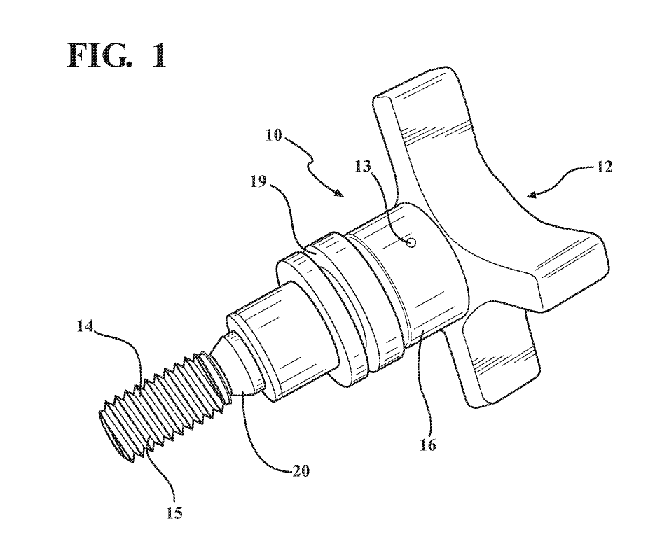

The captive bolt fastener of present invention is shown generally at 10 in FIG. 1. Typically, captive fasteners or bolt fasteners 10 are used for repeatedly attaching one workpiece or template to another. Because of the repetitive nature of the attaching and removing of the fasteners, they are left in bushings that are fixed to one of the work pieces. The purpose of the captive fastener is to keep the fastener in the bushing so that it is not lost.

The captive bolt fastener 10 of the present invention has a fastener or bolt 14. The bolt 14 has an elongated shaft 9. A handle 12 is connected to a bolt 14. In the disclosed embodiment the handle 12 is fastened to the bolt 14 with a set screw 13. It will be appreciated that any number of common fastening methods could be used, such as for example, welding, soldering, integral formation, etc. Additionally, other handles could be used, such as a t-handle, any of the multitude of screw drive types, such as hex heads, hex sockets, allen wrench sockets, slotted, phillips head, etc.

The bolt 14 is threaded at 15. The end 15 is adapted to be received by a complementary receiver 11 attached or associated with a workpiece or pickup to which the primary workpiece or template is to be attached. The receiver 11 in the disclosed embodiment is an internally threaded nut. The captive bolt 10 includes a captive bushing 16 that is adapted to allow the bolt 14 to reciprocate within the bushing 16 for fastening and unfastening and be fixed to the primary work surface. Various methods can be used to fix the bushing 16 to the workpiece, for example, it can be press fit, welded, deformed into the metal for more permanent applications or as illustrated, a lock screw 17 can be used to attach the bushing 16 to the workpiece.

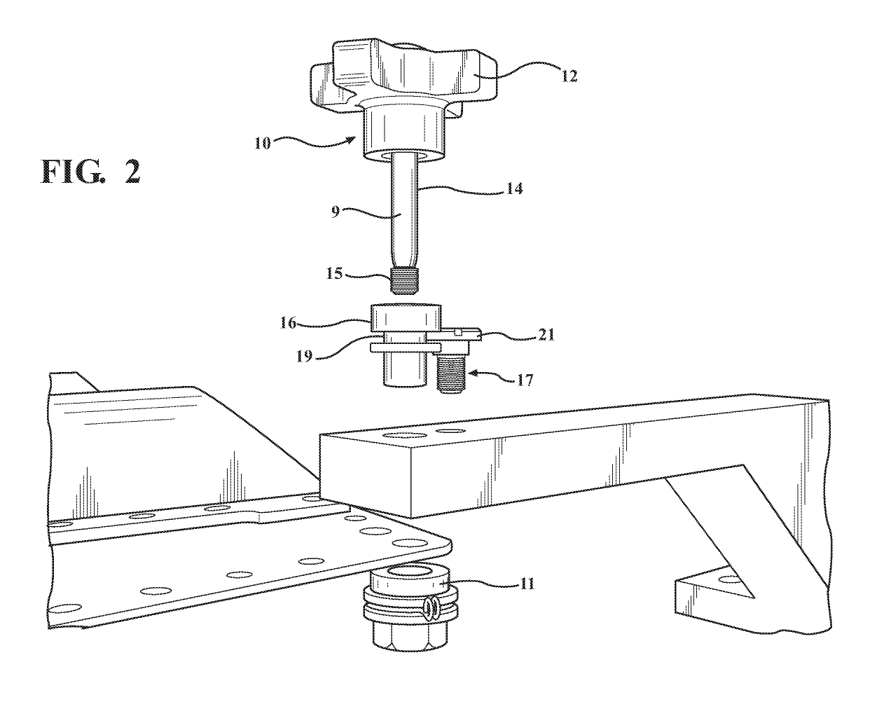

With reference to FIG. 2, the illustrated captive bolt 10 is connected to the workpiece by a lock screw 17. The captive bushing has a circumferential groove 19 for receipt of the head 21 of the lock screw. As is known, the lock screw 17 is threaded into an adjacent opening in the work piece or pickup with the head 21 of the screw being partially received in the circumferential groove 19 in the bushing.

The bushing 16 includes a bore 23 with an internal snap ring 29 mounted within a channel 25 in the bore 23 of the bushing 16. The channel 25 is near the proximal end of the bushing 16 away from the threads 15. The fastener 14 has a sloped section 22 that slopes from the shaft of the fastener 14 downwardly towards the threads. The sloped section 22 allows the fastener 14 to be moved between the retracted and extended positions more easily.

To prevent the bushing 16 from engaging the threads, camming onto the threads or even coming out of the bushing 16, a groove 20 is formed adjacent the threads to create a flat wall 27 adjacent the threads 15. The groove 20 receives the snap ring when the fastener 14 is retracted into the bushing 16. The snap ring engages into the groove 20 to allow the fastener 14 to be retracted into the bushing 16 and held by the snap ring in the retracted position. The groove 20 is positioned directly adjacent the threads 15 of the bolt 14 and the flat wall 27 prevents the snap ring and thereby the bushing 16 from engaging the threads 15. The snap ring is adapted to be received within the groove 20 and to be retrained from engaging the threads 15 by the wall 27.

The snap ring within the bushing 16 engages the groove 20 preventing the bushing 16 from engaging the threads 15 and from being removed from the bushing 16. In this way, the bolt 14 cannot be inadvertently removed from the bushing 16. The groove 20 prevents removal of the bolt 14 from the bushing 16.

The foregoing invention has been described in accordance with the relevant legal standards, thus the description is exemplary rather than limiting in nature. Variations and modifications to the disclosed embodiment may become apparent to those skilled in the art and do come within the scope of the invention. Accordingly, the scope of legal protection afforded this invention can only be determined by studying the following claims.

We claim:

1. A captive fastener comprising:
a bushing having a body portion;
an internal bore extending through said body portion;
a snap ring mounted within said internal bore;
a fastener having an elongated shaft, said elongated shaft mounted within said bore and adapted to reciprocate within said bore between retracted and extended positions;
threads formed on one end of said fastener;
a sloped section extending from a space distance above said threads, said sloped section having a first larger diameter tapering from said spaced distance above said threads to a second smaller diameter adjacent said threads;
a flat wall adjacent said threads;
said snap ring engaging said bolt when said shaft is extended and retracted, said flat wall preventing said snap ring from engaging said threads, said sloped surface facilitating the expansion of said snap ring as said bolt is moved to said extended position.

2. The captive fastener of claim 1, further including a groove positioned directly adjacent said flat wall.

3. The captive fastener of claim 2, wherein said snap ring enters said groove to retain said bolt in said retracted position.

4. A captive fastener comprising:
a bushing having a body portion;
an internal bore extending through said body portion;
a snap ring mounted within said internal bore;
a fastener having an elongated shaft, said elongated shaft being adapted to be mounted within said bore and adapted to reciprocate within said bore between retracted and extended positions;
threads formed on one end of said fastener;
a sloped section extending from a space distance above said threads, said sloped section having a first larger diameter tapering from said spaced distance above said threads to a second smaller diameter adjacent said threads;
a groove positioned directly adjacent said threads;
a flat wall adjacent said groove;
said snap ring engaging said bolt when said shaft is extended and retracted, said flat wall preventing said snap ring from engaging said threads, said snap ring entering said groove when said bolt is in said retracted position to maintain said bolt in said retracted position and said sloped surface facilitating the expansion of said snap ring as said bolt is moved to said extended position.

5. The captive fastener of claim 4, wherein said snap ring enters said groove to retain said bolt in said retracted position.

6. A captive fastener comprising:
a bushing having a body portion;
an internal bore extending through said body portion;
a snap ring mounted within said internal bore;
a fastener having an elongated shaft, said elongated shaft mounted within said bore and adapted to reciprocate within said bore between retracted and extended positions;
threads formed on one end of said fastener;
a flat wall adjacent said threads;
said snap ring engaging said bolt when said shaft is extended and retracted, said flat wall preventing said snap ring from engaging said threads.

7. The captive fastener of claim 6 further including a groove positioned directly adjacent said flat wall.

8. The captive fastener of claim 7, wherein said snap ring enters said groove to retain said bolt in said retracted position.

9. The captive fastener of claim 6, further including a sloped section extending from a space distance above said threads, said sloped section having a first larger diameter tapering from said spaced distance above said threads to a second smaller diameter adjacent said threads; said sloped surface facilitating the expansion of said snap ring as said bolt is moved to said extended position.
